(19) United States
(12) Patent Application Publication
(10) Pub. No.: US 2003/0003218 A1
(43) Pub. Date: Jan. 2, 2003

(54) Food ingredients derived from hulled viscous barley grain and the process of making

(76) Inventors: Gregory Joseph Fox, Fargo, ND (US); Dale Rogers Clark, Bozeman, MT (US)

Correspondence Address: Gregory J. Fox, 717 14th St. S., Frago, ND, 58103, US

(21) Appl. No.: 10/173,868

(22) Filed: Jun. 18, 2002

Related U.S. Application Data
(60) Provisional application No. 60/298,821, filed on Jun. 18, 2001.

(51) Int. Cl. A23L 1/168

(52) U.S. Cl. 426/618

(57) ABSTRACT

Disclosed is a waxy barley pearl containing high levels of viscous beta-glucan. Also described are the methods to produce this product.

### CROSS REFERENCE

This application claims priority under 35 USC §119 (e) to U.S. Provisional Application Serial No. 60/298,821 filed on Jun. 18, 2001

### FIELD OF THE INVENTION

The present invention relates to a single food product, high viscosity hulled waxy barley pearl, which is a potent source of clinically active viscous beta-glucan, which has hypocholesterolaemic, immunostimulating, gluco-regulating, and antitumorogenic properties. This material can be used directly as a food or food ingredient, or undergo further processing into flour, flakes, kibbles, or other processed ingredients.

### BACKGROUND OF THE INVENTION

In previous patents filed by this group (Fox, U.S. Pat. Nos. 5,614,242; 5,725,901; 6,197,952; 6,238,719B1), high viscosity food products derived from waxy hulless and waxy hulless short awn barley have been described and successfully patented. These products include high viscosity flours, fiber concentrates, tocotrienols concentrates, kibbles, cut flaked and purified beta-glucan isolates. Most of these products can be made from whole grain or pearled grain. The high viscosity is created by long beta-glucan fibers that swell in aqueous solution and create viscosity. This viscosity is the basis for clinical activity which includes serum cholesterol reduction, glycemic index reduction, and possibly creates immunostimulation of the immune cells of the intestinal mucosae. Normal barley does not yield viscous beta-glucan product. Selected waxy hulless and waxy hulless short awn barleys do. Use of these two types of barley genotypes was the basis of all the previous patents granted to this group.

Most recently it has been discovered that another genotype/processing treatment combination can yield the beta-glucan viscosity that has here-to-fore been associated only with waxy hulless or waxy hulless short awn genotypes. It has been found that there are certain waxy hulled genotypes that upon pearling will yield pearled grain with the same high beta-glucan viscosity profile as high viscosity waxy hulless barley. Some of these genotypes when pearled at a high level (30%) yielded barley pearls equal to high viscosity waxy hulless barley pearls. Very surprising. These high viscosity waxy hulled types have a beta-glucan viscosity greater than 10 cps in the grain with a beta-glucan content exceeding 6% upon pearling of 10% up to 30% they yield pearled grain with a viscosity of 15 cps or greater and can be used in place of high viscosity waxy hulless or waxy hulless short awn barley for many applications. This information is summarized in Table 1. Note entries Merlin, Meresse, and Azhul are high viscosity waxy hulless barleys. By definition such barleys have a viscosity reading (for a 5% aqueous solution of whole grain flour) of 15 cps or higher (bottom table). Pearling slightly decreases this viscosity for Merlin from 29.3 cps to 28.7 cps and increases for Azhul from 32.5 cps to 74 cps. However, quite surprising it was found that by pearling selected waxy hulled genotypes, beyond the normal pearling level (5-20%), to 30% pearl, a high viscosity barley pearl that equaled that of waxy hulless types was

TABLE 1
Beta-glucan content and alkaline extract viscosity of
barley varieties and pearled samples.

| Sample | | Starch/Hull | Beta-glucan | Viscosity |
|---|---|---|---|---|
| No. | Sample Description | Type | % (dry weight) | (cps) |
| 059 | Meresse | Waxy/ | 6.6 | 17.8 |
| | | Hulless | | |
| 060 | Merlin | Waxy/ | 7.5 | 29.3 |
| | | Hulless | | |
| 061 | Merlin- | Waxy/ | 7.5 | 28.7 |
| | pearled 10% | Hulless | | |
| 066 | Azhul | Waxy/ | 8.6 | 32.5 |
| | | Hulless | | |
| 067 | Azhul- | Waxy/ | 11.2 | 74.0 |
| | pearled 10% | Hulless | | |
| 062 | Waxy Gustoe¹ | Waxy/ | 6.5 | 12.6 |
| | white² | Hulled | | |
| 063 | Waxy Gustoe | Waxy/ | 7.4 | 16.0 |
| | white- | Hulled | | |
| | pearled 13% | | | |
| 064 | Waxy Gustoe | Waxy/ | 7.5 | 10.3 |
| | blue² | Hulled | | |
| 065 | Waxy Gustoe | Waxy/ | 8.3 | 21.2 |
| | blue- | Hulled | | |
| | pearled 12% | | | |
| 068 | Gustoe- | Nonwaxy/ | 6.4 | 5.5 |
| | pearled 30% | Hulled | | |
| 069 | Waxy Gustoe | Waxy/ | 9.1 | 19.0 |
| | blue- | Hulled | | |
| | pearled 30% | | | |
| 070 | Nebula- | Nonwaxy/ | 6.7 | 9.0 |
| | pearled 30% | Hulled | | |
| 071 | Waxy Nebula¹- | Waxy/ | 11.4 | 11.5 |
| | pearled 30% | Hulled | | |
| 072 | Baronesse- | Nonwaxy/ | 5.6 | 6.4 |
| | pearled 30% | Hulled | | |
| 073 | Waxy Baronesse-1¹- | Waxy/ | 7.4 | 29.0 |
| | pearled 30% | Hulled | | |
| 074 | Waxy Baronesse-2- | Waxy/ | 8.3 | 30.0 |
| | pearled 30% | Hulled | | |

¹These represent isogenic versions of normal parental varieties.
²White or blue refers to aleurone color, parental variety Gustoe is blue.

developed. It can be seen in Table 1 that each of the two samples of the entry designated as Waxy Baronesse when pearled 30% slightly exceeded the viscosity of Merlin pearled 10%. Thus the waxy Baronesse could be used in those high beta-glucan, high viscosity products that call for a pearled flake. This includes isolates, concentrated, flour, kibble and flakes that call for a pearled high viscosity waxy hulless seed as initial starting material. It should be noted that this material could not be used for whole grain derived products described in previous patents because pearling is a form of reduction milling rendering a non-whole grain end product.

While it was most surprising to produce high viscosity waxy hulled pearl that equaled a quality high viscosity waxy pearl with 30% pearling, it was also surprising that with less pearling (10-12%) Waxy Gustoe White and Waxy Gustoe Blue yielded a pearled grain, which retained grain like qualities due to reduced pearling loss, with beta- glucan viscosity exceeding 15 cps. This material could be used in place of high viscosity waxy hulless barley or waxy hulless short awn barley as the pearling simply removed the cemented hull (10-12% of the hulled seed) creating a sort of mechanized waxy hulless barley. This was quite surprising and does not work with all waxy hulled genotypes. This effect is observed only in waxy hulled material that has a beta-glucan content greater than 6% and a whole grain viscosity of 10 cps. These lines are called high viscosity hulled waxy barley lines, because upon hull removal (10-15% pearling) they yield a mechanically produced waxy hulless barley with beta-glucan viscosity greater than 15 cps, which is the standard for high viscosity waxy hulless barley.

This discovery has great economic importance. The use of hulled waxy lines has some very important inherent advantages over waxy hulless and waxy hulless short awn lines. The cemented hull protects the seed during development and improves seed fill. This results in a yield advantage. Farmers are far more accustomed to harvesting covered barley and the harvestability of hulled types is generally superior to that of hulless types. Because of all these factors production costs of waxy hulless barley is about 1/3 greater than hulled feed or malting barley, but this is more than offset by the cost of pearling. Thus for high viscosity food products the waxy hulless source is still optimum. However, all the US and foreign grain markets are geared toward hulled barley. Hulless barleys are still an experimental entity. Thus waxy hulled types are a form of barley that qualify as standard feed barley. They fit in the commercial channels, and the government subsidy programs. Waxy hulless barleys do not. A farmer can grow waxy hulled barley as a feed grain and make a profit, but if a domestic human food market opens up he may be able to turn around and sell that same waxy hulled barley at a premium. In short the invention described herein allows the incorporation of the high viscosity waxy barley beta-glucan in material (hulled barley) that is acceptable to the commercial grain industry as it exist today.

### PRIOR ART

It is well known to those skilled in the art/technology of pearling that pearling can increase beta-glucan content and viscosity in barley pearl, and that this effect can be pronounced in the case of waxy hulless barley (Bhatty and Rossnagel, Cereal Chemistry 75(1):15-21,1998). However, the invention described herein combines elements of genetics, agronomics, and mechanics (pearling) to create a process to convert specially selected waxy hulled barley grain into a form of waxy hulless barley rendered hulless by pearling, not genetics. This is done to create a very specific product, high viscosity waxy hulled barley pearl which can be used in place of high viscosity waxy hulless barley in many food products including some of those described in U. S. Pat. Nos. 5,613,242; 5,725,901; 6,917,95281; 6,238,71981. With further pearling (beyond 15% up to 30%) high viscosity waxy hulled barley pearls can be used in place of high viscosity waxy hulless barley pearls. This product and process has been described nowhere else.

The nature of high viscosity waxy hulless barley is described in some detail in Fox, U. S. Pat. No. 5,614,242. In that invention, long chained beta-glucan fibers are visually assayed. In the practice of the art of grain milling and evaluation it was found (some what unexpectedly) that in the waxy hulled type, material with large quantities of viscous beta-glucan could be identified by a 3 step process including selection of a good waxy genotype (at least 97% of seed stain brown), with beta-glucan content greater than 6%, and a beta-glucan viscosity greater than 10 cps; eliminating the need of beta-glucan chain analysis. When pearled (0.10-15%) this material yielded a pearl that mimicked high viscosity waxy hulless barley. This is a unique approach which has rendered a unique product, described in no other patent or publication.

### BRIEF SUMMARY OF THE INVENTION

The present invention is a high viscosity hulled barley pearl containing high levels of clinically active viscous beta-glucan this pearled barley can be used directly as an ingredient in a wide array of foods; soups salads, pilafs, side dishes, etc, or as starting material for production of flours, cereals, and other processed foods. The method of producing high viscosity hulled waxy barley pearl Includes the following steps:

1. selecting high viscosity hulled waxy barley grain;

with viscosity exceeding 10 cps; and,

with beta-glucan content exceeding 6%;

2. pearling away 10-30% of the grain yielding a pearled grain;

with a viscosity greater than 15 cps.

### DETAILED DESCRIPTION OF THE INVENTION

In order to provide an understanding of some of the more important terms used in the specifications and claims, the following definitions are provided. Beta-glucan—the term beta glucan (beta 1-4/1-3 glucosyl pyranose polymer) is intended to refer to the name of a non starchy polysaccharide in which individual glucose molecules (20,000-1,000,000) are linked by beta 1-4 and beta 1-3 linkages. Beta-glucan is soluble in warm water (40-45 degrees Centigrade), cellulose is insoluble in water. Beta-glucan is the main structural material in the cell walls of barley and oat grain.

Beta-glucan viscosity—the term beta-glucan viscosity describes the friction that is created in a solution by the presence of beta glucan chains (fibers) and is measured in cps. All beta-glucan viscosities reported herein are measured on a 5% aqueous suspension of ground grain or ground grain fractions.

Centipoise Units (cps)—the term Centipoise Units or (cps) is the name of the units commonly used to measure viscosity. By definition the fundamental unit of viscosity measurement is the “Poise”, which is a material requiring a sheer stress of one dyne per square centimeter to produce a sheer of one inverse second, which has a viscosity of one poise or 100 centipoise.

Good waxy barley—individual waxy barley kernels, when cut and stained with iodine, stain brown; nonwaxy barley kernels stain blue. A perfect sample of hulled waxy barley will stain 100% brown. However, there are a number of ways that purity is eroded (out crossing, nonwaxy barley impurities picked up in production and seed cleaning, and back mutations). In order to preserve the quality of waxy barley products, good waxy barley is called for and is defined as a seed lot with 95% or more of the kernels staining brown.

High viscosity hulled waxy barley grain—is barley grain with greater than 6% beta- glucan content and beta-glucan viscosity greater than 10 cps.

High viscosity hulled waxy barley pearl—is a pearl with a beta-glucan viscosity greater than 15 cps.

Isogenic lines—two or more lines differing from each other genetically at one locus only distinguished from clones, homozygous lines, identical twins, etc, which are identical at all loci. Sometimes more than one gene is isolated, often 2 or 3 genes are isolated. These are called double and triple isogenics, respectively.

Normal hulled (non waxy) barley—is a grain with an adhering (cemented) hull. It contains a mix of hard straight chained amylose (25%) and soft branched amylopectin starch resulting in hard starch granules, which stain blue with Iodine.

Pearling—the term pearling refers to a form of incomplete milling in which the grain is rotated (tumbled) over an abrasive surface in order to remove a portion of the outer seed layers or hulls. Hulled grain like barley or rice are routinely pearled to remove the adhering hulls. Hulless grains like wheat corn or hulless barley can be pearled to remove the bran layer or the pericarp/aleurone seed layer, prior to grain milling, resulting in a cleaner flour with less bran.

Polishing—This is a term often used by those skilled in the art of pearling. It is a radial grinding form of processing just like pearling and yields finished products that are essentially pearls. In general, polishing implies a lesser degree of milling (often less than 10% of the outer layers of seed pearled away) but can include any level of milling. For the purposes of this invention the terms pearling and polishing are synonymous.

Viscosity—the term viscosity is the measure of fluid friction. A highly viscous material is one that possesses a great deal of internal friction, it will not pour or spread as easily as material of lesser viscosity.

Waxy hulled barley—is a grain with an adhering (cemented) hull containing essentially 100% branched amylopectin starch resulting in soft starch granules that stain brown with Iodine. Terms “waxy hulled barley” and “hulled waxy barley” are synonymous.

Waxy hulless barley—is a grain with a non-adhering ( non-cemented} hull containing essentially 100% of branched amylopectin starch resulting in soft starch granules that stain brown with Iodine.

Waxy hulless short awn barley—is a grain that is just like waxy hulless barley except it is derived from a plant with a short glume awn. This results in a smaller seeded grain.

In the preferred embodiment of this invention hulled waxy barley lines are evaluated for % beta-glucan and beta-glucan viscosity, and categorized as high viscosity or low viscosity lines, with high viscosity lines having a beta-glucan content above 6% in the whole grain with beta-glucan viscosity above 10 cps. Low viscosity lines have grain with beta-glucan content below 6% and/or beta-glucan viscosity below 10 cps. Selected high viscosity hulled waxy barley lines are grown in semi-arid areas such as the Western USA (the Missouri Plateau and points west}, which have low relative humidity conditions which favor accumulation of viscous beta-glucan. These lines are harvested and stored in a manner that prevents water damage or sprouting, which destroy beta-glucan and beta-glucan viscosity.

The production of this material requires a combination of favorable genetic and agronomic (environmental) factors. Select high viscosity hulled waxy barley lines will not in every case yield high viscosity hulled waxy grain. By the same token some low viscosity hulled waxy barley lines if grown in a most favorable environment may achieve the desired beta-glucan % and viscosity. The only absolute requirement is that the lines must be waxy. The waxy gene causes a disruption of starch accumulation that result in the storage of free beta-glucan fibers in the cell walls as an alternate storage polysaccharide. It is these free soluble fibers that cause the elevated beta-glucan content and viscosity. Because of this selection of raw material for pearling must be based on the measured beta-glucan content and viscosity of hulled waxy grain samples. Grain lots only become high viscosity hulled waxy barley upon successful testing. The very best glucan producing lines can be undone by environmental conditions.

Once a superior high viscosity hulled waxy seed lot has been selected the high viscosity hulled waxy barley pearled grain can be produced by pearling away between 10 to 30% of the outer layers of the grain. The more that is pearled away the greater the enhancement of beta-glucan viscosity. However all practical benefits are achieved within the 10 to 30% pearling interval. As a practical matter, the desired product will be achieved with 10-15% pearling; However as pearling is increased so is the beta-glucan viscosity so that classes of products can be produced:

10-15% pearling yields a high viscosity hulled waxy pearl;

16-22 pearling yields a higher viscosity hulled waxy pearl;

17-30% pearling yields a highest viscosity hulled waxy pearl.

Once a high viscosity hulled waxy pearl has been achieved, further processing could include additional pearling to yield more refined products such as a baby pearl (55% pearl) or a split pearl in which the high viscosity waxy hulled pearl is split down the crease and pearled to produce a rice-like grain pearl.

Thus, the preferred embodiment of this invention includes the following steps:

1. selection of high viscosity hulled waxy barley genotypes like Waxy Gustoe White or Waxy Gustoe Blue (Table 1);

2. production of seed in a low relative humidity area such as the American West (west of the Missouri plateau);

3. harvest seed in a timely fashion, avoiding sprout damage;

4. select seed lots that meet the high viscosity hulled waxy barley criteria of: 6% beta-glucan; and, 10 cps viscosity;

5. pearl samples to remove 10-30% of outer seed layer to yield high viscosity hulled waxy pearl with beta-glucan viscosity greater than 15 cps;

6. Gradations* can be achieved with: 10-15% pearl yielding high viscosity hulled waxy pearl; 16-22% pearl yielding higher viscosity hulled waxy pearl; 17-30% pearl yielding highest viscosity hulled waxy pearl. * The gradation categories would only be valid within a particular seed lot, not between seed lots.

### EXAMPLES

The following examples are provided to further illustrate the present invention and are not intended to limit the invention beyond the limitations set forth in the appended claims.

The following examples are all taken from the Table 1 for the purpose of logical comparison, but are arranged in the following 5 examples as subsets of the data in that table for the purpose of logical comparison. It is hoped in that way to better illustrate the invention contained herein.

### EXAMPLE 1

These are examples of high viscosity waxy hulless barley, which have elevated levels beta-glucan and beta-glucan viscosity. Normal hulled barley will range between 3-5% beta-glucan, with viscosity between 3-7 cps.

| | | Beta-glucan | Viscosity |
|---|---|---|---|
| Type | Variety | % (dry weight) | (cps) |
| Waxy hulless | Meresse | 6.6 | 17.8 |
| Waxy hulless | Merlin | 7.5 | 29.3 |
| Waxy hulless | Azul | 8.6 | 32.5 |

### EXAMPLE 2

These are examples of two isogenic waxy hulled versions of the variety Gustoe. Both versions would qualify as high viscosity hulled waxy barley. Note the characteristic increase in beta-glucan viscosity upon pearling (13 and 12%), resulting in the production of high viscosity hulled waxy pearl.

| | | Pearl | Beta-glucan | Viscosity |
|---|---|---|---|---|
| Type | Variety | % | % (dry weight) | (cps) |
| Waxy hulled | Waxy Gustoe White | 0 | 6.5 | 12.6 |
| Waxy hulled | Waxy Gustoe White | 13 | 7.4 | 16.0 |
| Waxy hulled | Waxy Gustoe Blue | 0 | 7.5 | 10.3 |
| Waxy hulled | Waxy Gustoe Blue | 12 | 8.3 | 21.2 |

### EXAMPLE 3

This example shows the effect of light pearling on high viscosity waxy hulless barley. In the case of Merlin pearling had no effect, while in the case of Azhul it had a very pronounced effect increasing both % beta-glucan and beta-glucan viscosity. The effect of light pearling (10-15%) is more consistent with high viscosity waxy hulled barley, and should always result in increased % beta-glucan and beta-glucan viscosity

| | | Pearl | Beta-glucan | Viscosity |
|---|---|---|---|---|
| Type | Variety | % | % (dry weight) | (cps) |
| Waxy hulless | Merlin | 0 | 7.5 | 29.3 |
| Waxy hulless | Merlin | 10 | 7.5 | 28.7 |
| Waxy hulless | Azul | 0 | 8.6 | 32.5 |
| Waxy hulless | Azul | 10 | 11.2 | 74.0 |

### EXAMPLE 4

This is a comparison between two normal hulled lines and their waxy hulled counterpart. Note that even a high rate of pearling does not greatly enhance the beta-glucan content or viscosity of the normal types. Also note that Waxy Gustoe Blue shows a good reaction to pearling yielding 9.1% beta-glucan with a viscosity of 19 cps, it qualifies as a high viscosity hulled waxy barley. Note that Waxy hulled Nebula fails in this regard, despite a 30% pearl and beta-glucan content of 11.4% it only reaches a viscosity of 11.5. This variety does not qualify as a high viscosity hulled waxy barley.

| | | Pearl | Beta-glucan | Viscosity |
|---|---|---|---|---|
| Type | Variety | % | % (dry weight) | (cps) |
| Normal hulled | Gustoe | 30 | 6.4 | 5.5 |
| Waxy hulled | Waxy Gustoe Blue | 30 | 9.1 | 19.0 |
| Normal hulled | Nebula | 30 | 6.7 | 9.0 |
| Waxy hulled | Waxy Nebula | 30 | 11.4 | 11.5 |

### EXAMPLE 5

In this example, two waxy hulled isogenic versions of the variety Baronesse are compared to the parent variety Baronesse. The two hulled waxy isogenic lines were selected for beta-glucan content and viscosity and as such are high viscosity hulled waxy barleys. Note the elevated levels of beta-glucan and viscosity in the 30% pearl of both waxy hulled varieties, thus a high viscosity hulled waxy pearl was yielded for both Waxy Baronesse 1 and Waxy Baronesse 2. Also, note the extremely low level of beta-glucan and viscosity for parental type Baronesse. This last example is a clear demonstration of the power of the waxy gene in combination with pearling to greatly increase beta-glucan content and viscosity in pearled barley grain.

| | | Pearl | Beta-glucan | Viscosity |
|---|---|---|---|---|
| Type | Variety | % | % (dry weight) | (cps) |
| Normal hulled | Baronesse | 30 | 5.6 | 6.4 |
| Waxy hulled | Waxy Baronesse-1 | 30 | 7.4 | 29.0 |
| Waxy hulled | Waxy Baronesse-2 | 30 | 8.3 | 30.0 |

what is claimed is:

1. A method of producing a high beta-glucan viscosity hulled waxy barley pearl with a beta-glucan viscosity greater than 15 cps, the method comprises the following steps;
selecting a hulled waxy barley grain with a beta-glucan content exceeding 6% and a beta-glucan viscosity exceeding 10 cps;
pearling away 10-30% of the outer layer of the barley grain resulting in a waxy barley pearl with beta-glucan viscosity exceeding 15 cps.

2. The high beta-glucan viscosity hulled waxy barley pearl with a beta-glucan viscosity greater than 15 cps, produced by the method of claim 1.
